(19) United States
(12) Patent Application Publication
(10) Pub. No.: US 2013/0110499 A1
(43) Pub. Date: May 2, 2013

(54) INFORMATION PROCESSING DEVICE, INFORMATION PROCESSING METHOD AND INFORMATION RECORDING MEDIUM

(71) Applicant: CASIO COMPUTER CO., LTD., Tokyo (JP)

(72) Inventors: Tomoharu Yamaguchi, Kodaira-shi (JP); Katsuhiko Satoh, Hachioji-shi (JP)

(73) Assignee: CASIO COMPUTER CO., LTD., Shibuya-ku, Tokyo (JP)

(21) Appl. No.: 13/656,893

(22) Filed: Oct. 22, 2012

(30) Foreign Application Priority Data
Oct. 27, 2011 (JP) 2011-236417
Feb. 20, 2012 (JP) 2012-034573

(51) Int. Cl. G06F 17/27

(52) U.S. Cl. 704/9

(57) ABSTRACT

A word string acquirer unit acquires a word string including a plurality of words. An extractor extracts partial strings including words contained in the word string acquired by the word string acquirer. A division pattern generator generates division patterns containing division flags indicating whether or not the word string acquired by the word string acquirer is divided at spaces between the words contained in the partial strings extracted by the extractor. The division probability coefficient acquirer acquires division probability coefficients indicating a degree of a certainty that the word string is divided with a division method indicated by the division patterns generated by the division pattern generator, for each of the partial strings extracted by the extractor. A partitioning unit partitions the word string based on the division probability coefficients acquired by the division probability coefficient acquirer.

### CROSS-REFERENCE TO RELATED APPLICATION

This application claims the benefit of Japanese Patent Application No. 2011-236417, filed on Oct. 27, 2011, and Japanese Patent Application No. 2012-034573, filed on Feb. 20, 2012, the entire disclosures of which are incorporated by reference herein.

### FIELD

This application relates generally to an information processing device, an information processing method and an information recording medium.

### BACKGROUND

A device is known which divides a word string containing multiple words by meaning, and displays to a user the results of translating the divided words into another language and analyzing the meaning. With regarding to this kind of device, technology has been proposed for estimating between which words the word string to be analyzed should be divided.

For example, Unexamined Japanese Patent Application Kokai Publication No. H6-309310 proposes technology for estimating how to divide the word string using a syntax analyzer programmed in advance with grammar rules for the language to which the word string to be analyzed belongs. With this Literature, a syntax analyzer programmed with grammar rules for the language to which the text belongs is used for estimating between what words the text should be divided. Consequently, the estimation precision of the division method depends on the precision of the syntax analyzer. However, the problems arise that it is difficult to create a highly precise syntax analyzer, and the volume of calculations becomes large in order to execute highly precise syntax analysis.

In addition, Unexamined Japanese Patent Application Kokai Publication No. H10-254874 proposes art for partitioning text strings not separated by spaces into words. In this Literature, technology is disclosed for partitioning text strings not separated by spaces into words. However, no method is disclosed for determining between what words a text string is to be partitioned.

In consideration of the foregoing, it is an object of the present invention to provide an information processing device, an information processing method and an information recording medium that can divide a word string to be analyzed, without using a syntax analyzer.

### SUMMARY

To achieve the above object, the information processing device according to a first aspect of the present invention comprises:
a word string acquirer for acquiring a word string including a plurality of words;
an extractor for extracting partial strings including words contained in the word string acquired by the word string acquirer;
a division pattern generator for generating a plurality of division patterns containing division flags indicating whether or not the word string acquired by the word string acquirer is divided at spaces between the words contained in the partial strings extracted by the extractor;
a division probability coefficient acquirer for acquiring, for each division pattern, division probability coefficients indicating a degree of a certainty that the partial strings are divided with a division method indicated by the division patterns generated by the division pattern generator, for each of the partial strings extracted by the extractor; and
a partitioner for partitioning the word string acquired by the acquirer, based on the division probability coefficients acquired by the division probability coefficient acquirer.

The information processing method according to a second aspect of the present invention comprises steps of:
acquiring a word string including a plurality of multiple words;
extracting partial strings including words contained in the acquired word string;
generating a plurality of division patterns containing division flags indicating whether or not the acquired word string is divided at spaces between the words contained in the extracted partial strings;
acquiring, for each division pattern, division probability coefficients indicating a degree of a certainty that the partial strings are divided with a division method indicated by the generated division patterns, for each of the extracted partial strings; and
partitioning the acquired word string, based on the acquired division probability coefficients.

The non-transitory information recording medium according to a third aspect of the present invention causes a computer to function as:
a word string acquirer for acquiring a word string including a plurality of words;
an extractor for extracting partial strings including words contained in the word string acquired by the word string acquirer;
a division pattern generator for generating a plurality of division patterns containing division flags indicating whether or not the word string acquired by the word string acquirer is divided at spaces between the words contained in the partial strings extracted by the extractor;
a division probability coefficient acquirer for acquiring, for each division pattern, division probability coefficients indicating a degree of a certainty that the partial strings are divided with a division method indicated by the division patterns generated by the division pattern generator, for each of the partial strings extracted by the extractor; and
a partitioner for partitioning the word string acquired by the word string acquirer, based on the division probability coefficients acquired by the division probability coefficient acquirer.

### BRIEF DESCRIPTION OF THE DRAWINGS

A more complete understanding of this application can be obtained when the following detailed description is considered in conjunction with the following drawings, in which:

FIG. 1A is a block diagram showing the functional composition of an information processing device;

FIG. 1B is a block diagram showing the hardware composition of an information processing device according to a first embodiment of the present invention;

FIG. 2A shows a photography image;

FIG. 2B shows the state when an input word string is decomposed;

FIG. 2C shows display data;

FIG. 3A shows an input character string and instructor data;

FIG. 3B shows a character string, division flags, tri-grams and division patterns;

FIG. 4 is a block diagram showing the composition of an analyzer;

FIG. 5 is a drawing for explaining the process executed by the analyzer;

FIG. 6 is a block diagram showing the composition of a probability coefficient output unit;

FIG. 7A shows an example of a tri-gram list;

FIG. 7B shows an example of a bi-gram list;

FIG. 7C shows an example of a mono-gram list;

FIG. 8A shows the process for computing the division probability coefficients of the tri-grams from the division probability coefficients of the bi-grams;

FIG. 8B shows the process for computing the division probability coefficients of the tri-grams from the division probability coefficients of the mono-grams;

FIG. 9 is a flowchart for explaining the information process;

FIG. 10 is a flowchart for explaining the partitioning process;

FIG. 11 is a flowchart for explaining the acquisition process;

FIG. 12 is a flowchart for explaining the calculation process;

FIG. 13 is a drawing showing the probability coefficient list;

FIG. 14A shows the process for calculating the probability coefficients of a third embodiment;

FIG. 14B shows the process for calculating the probability coefficients of a third embodiment;

FIG. 14C shows the process for calculating the probability coefficients of a third embodiment;

FIG. 15 is a flowchart for explaining the probability coefficient calculation process; and

FIG. 16 is a flowchart for explaining the probability coefficient calculation process.

### DETAILED DESCRIPTION

Below, the information processing device according to a preferred embodiment of the present invention is described with reference to the drawings. In the drawings, identical or corresponding parts are labeled with the same reference numbers.

### First Embodiment

An information processing device 1 according to a first embodiment has the functions enumerated in i to vii below:
i) a function for photographing paper and/or the like on which are recorded character strings (for example, a restaurant menu) belonging to a specific category that is to be analyzed;
ii) a function for identifying and extracting character strings that are to be analyzed from the photographed image;
iii) a function for analyzing the extracted character strings and dividing such into words;
iv) a function for outputting coefficients indicating the probability of being divided from a semantic point of view between words in the character string;
v) a function for dividing the character string based on the coefficients found;
vi) a function for acquiring display data explaining each of the fragments of the divided character string; and
vii) a function for displaying display data.

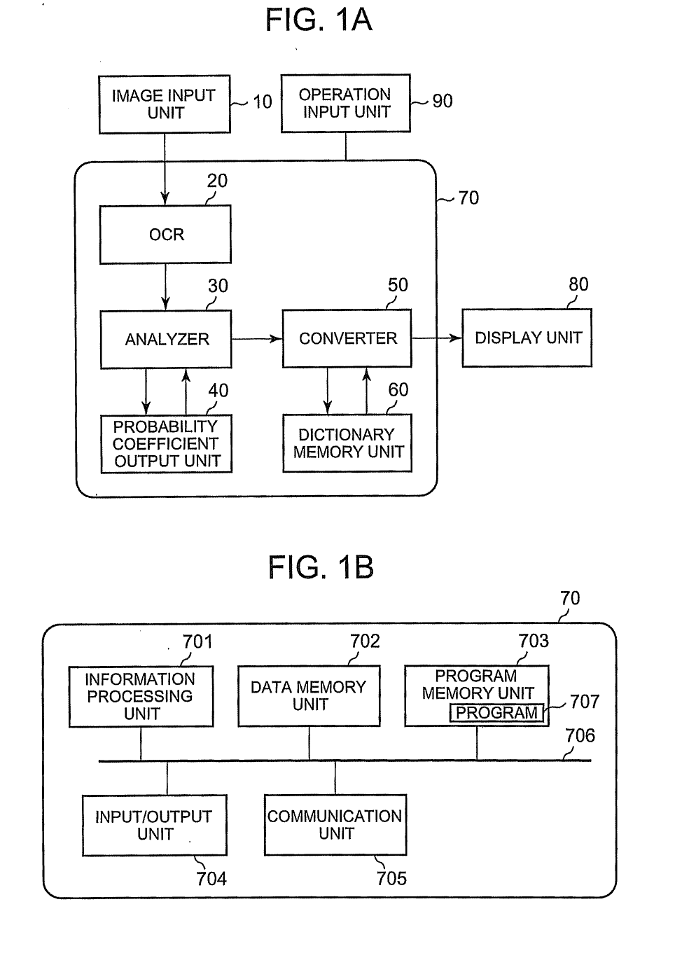

As shown in FIG. 1A, the information processing device 1 comprises an image input unit 10; an information processing unit 70 including an OCR (optical character reader) 20, an analyzer 30, a probability coefficient output unit 40, a converter 50 and a dictionary memory unit 60; a display unit 80; and an operation input unit 90.

The image input unit 10 is composed of a camera and an image processing unit. The image input unit 10 shoots subjects containing character strings and inputs the acquired images into the OCR 20.

The information processing unit 70 functions as the OCR 20, the analyzer 30, the probability coefficient output unit 40, the converter 50 and the dictionary memory unit 60.

The OCR 20 recognizes character strings contained in the images input from the image input unit 10, and acquires character strings written on the subject (for example, names of dishes written on a menu). The OCR 20 inputs the acquired character strings to the analyzer 30.

The analyzer 30 partitions the character string input from the OCR 20 into words and converts this into a word string W.

More specifically, the analyzer 30 extracts a continuous partial word string containing at least one of the words comprising the word string W. This partial word string is called an N-gram. Furthermore the analyzer 30 inputs into the probability coefficient output unit 40 the extracted N-gram and division pattern indicating between what words contained in that N-gram the word string W is divided from a semantic standpoint. The N-gram and division pattern are described below.

In addition, the analyzer 30 acquires from the probability coefficient output unit 40 a coefficient (hereafter called the “division probability coefficient”) indicating a degree of the certainty that the word string W was divided using the division method indicated by the division pattern. The analyzer 30 partitions the word string W using the division probability coefficient acquired from the probability coefficient output unit 40, and outputs this to the converter 50. The specific process the analyzer 30 executes is described below.

The probability coefficient output unit 40 acquires from the analyzer 30 an N-gram composed of N words (where N is an integer greater than or equal to 1), and a division flag indicating whether or not a division between words is made from a semantic standpoint. The probability coefficient output unit 40 records below-described instructor data in advance. When the N-gram and information containing the division flag (hereafter called the “division pattern”) are input from the analyzer 30, the probability coefficient output unit 40 acquires the division probability coefficients with reference to instructor data and inputs such to the analyzer 30. The specific process executed by the probability coefficient output unit 40 is described below.

The converter 50 references the dictionary memory unit 60 for each word comprising the partitioned word string W input from the analyzer 30 and generates display data. The converter 50 inputs each word comprising the word string W into the dictionary memory unit 60, and acquires from the dictionary memory unit 60 explanatory data for those words. The converter 50 generates display data in which a word and the explanatory data of that word are lined up, for each N-gram. The converter 50 inputs the generated display data to the display unit 80.

The dictionary memory unit 60 stores in advance a dictionary in which the words or word strings contained in the instructor data, and explanatory data explaining those words or word strings, are recorded associated with each other. When words or word strings are input from the converter 50, if those words or word strings are recorded in the dictionary, the dictionary memory unit 60 inputs the explanatory data recorded with those words or word strings associated with each other into the converter 50. In addition, if those words or word strings are not recorded in the dictionary, the dictionary memory unit 60 inputs empty data indicating this into the converter 50.

The display unit 80 is composed of an liquid crystal display and/or the like and displays display data input from the converter 50.

The operation input unit 90 is composed of an operation receiving device for receiving a user's operation, such as a touch panel, a keyboard, a button, a pointing device and/or the like, and a transmission unit for transmitting operation information received by the operation receiving device to the information processing unit 70. The operation input unit 90 inputs information indicating the operation content received from the user into the information processing unit 70.

Next, the hardware composition of the information processing unit 70 is explained. As shown in FIG. 1B, the information processing unit 70 is composed of an information processing unit 701, a data memory unit 702, a program memory unit 703, an input/output unit 704, a communication unit 705 and an internal bus 706.

The information processing unit 701 is composed of a CPU (central processing unit), a DSP (digital signal processing) and/or the like, and executes the below-described processes in accordance with a control program 707 stored in the program memory unit 703.

The data memory unit 702 is composed of a RAM (random access memory) and/or the like and is used as a work space for the information processing unit 701.

The program memory unit 703 is composed of non-volatile memory such as flash memory, a hard disk and/or the like, and stores the control program 707 for controlling actions of the information processing unit 701, and various types of data.

The communication unit 705 is composed of a LAN (local area network) device, modem and/or the like, and sends process results from the information processing unit 701 to external equipment connected via LAN circuits or communications circuits. In addition, the communication unit 705 receives information from external equipment and transmits such to the information processing unit 701.

The information processing unit 701, the data memory unit 702, the program memory unit 703 and the input/output unit 704 are respectively connected by an internal bus 706 and can send and receive information.

The input/output unit 704 controls input and output of information among the image input unit 10, the display unit 80, the operation input unit 90, external devices and/or the like connected to the information processing unit 70 by a USB (universal serial bus) or a serial port.

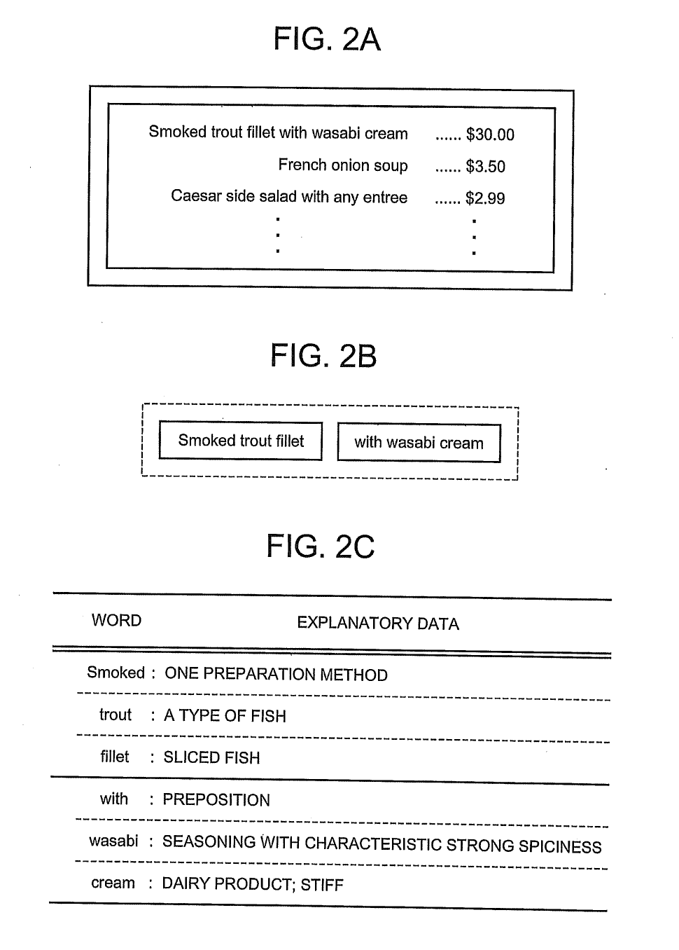

Next, a specific example of images the information processing device 1 takes of a subject, partitioned character strings and display data are explained with reference to FIGS. 2A, 2B and 2C.

The information processing device 1 acquires a photographed image such as that shown in FIG. 2A when a user photographs a subject, for example a restaurant menu and/or the like, using the image input unit 10.

The OCR 20 extracts character strings from the photographed image. The analyzer 30 partitions an extracted character string into words, and the partitioned word string such as shown in FIG. 2B is input into the converter 50. Furthermore, the converter 50 generates display data with an appended explanation or translation for each partitioned word string, as shown in FIG. 2C, and displays such.

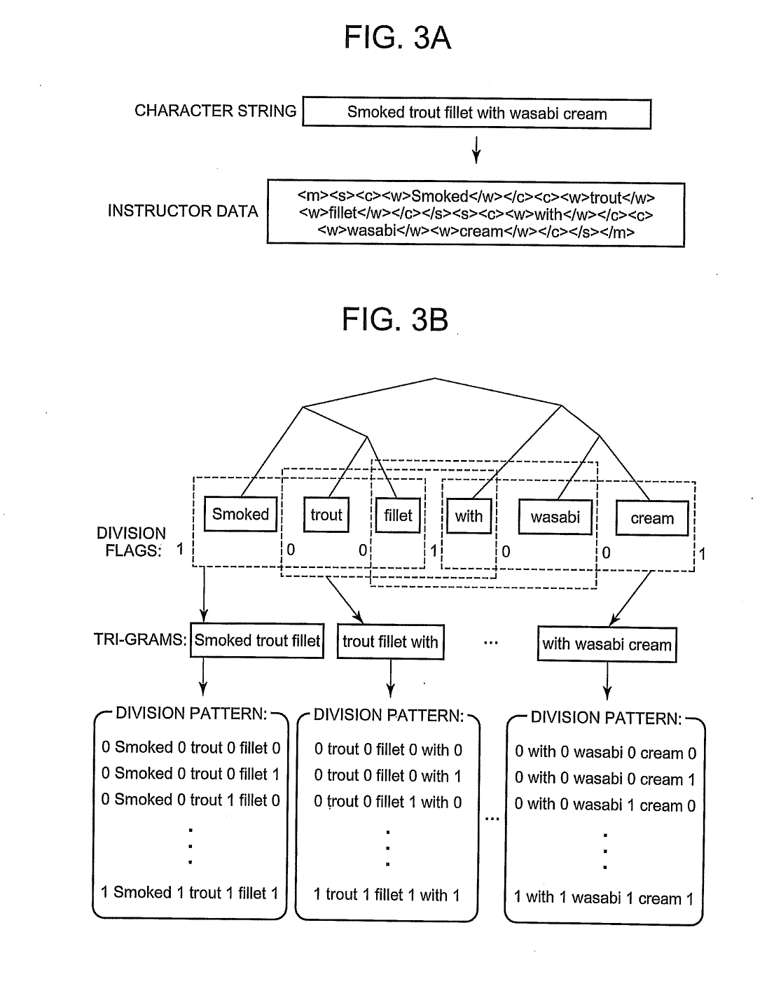

Next, the character string that is to be analyzed, the instructor data, the N-grams, the division flags and the division patterns are explained with reference to FIGS. 3A, 3B, and 3C.

The character string that is to be analyzed in this preferred embodiment is a character string showing a menu of food dishes, such as that shown in FIG. 3A. A tag is appended to the menu item “smoked trout fillet with wasabi cream,” and data partitioned for each word or each cluster is the tagged character string, that is to say the instructor data. In the example in FIG. 3A, the instructor data is
“<m><s><c><w>Smoked</w></c><c><w>trout</w><w>fillet</w></c></s><s><c>wi th</w></c><c><w>wasabi</w><w>cream</w></c></s>></m>”. The instructor data is data that a person or syntax analyzer created by collecting and tagging character strings belonging to specific categories of specific words. The types and categories of words are not limited by the present invention and may be arbitrary.

In the instructor data of FIG. 3A, the character string is partitioned by the tags <w> and </w> into the six words of “Smoked”, “trout”, “fillet”, “with”, “wasabi” and “cream”. In addition, these are partitioned by the tags <c> and </c> into the four fragments of “Smoked”, “trout fillet”, “with” and “wasabi cream”. Furthermore, these are partitioned by the tags <s> and </s> into the two fragments of “Smoked trout fillet” and “with wasabi cream”. The tags <m> and </m> are tags for dividing the recognized character string by dish.

The character string indicated by this instructor data is divided by the tags <w>, </w>, <c>, </c>, <s>, </s>, <m> and </m>, but the way of defining these tags is not limited to this. For example, it would be fine for the character string to be divided for each word or cluster of multiple words, and to be divided by a unique mark or a space.

The relationship among the recognized character string, the instructor data, the division flags, the N-grams and the division patterns is shown in FIG. 3B. A combination of N-grams with N consecutive words extracted, such as from the first word through the Nth word, or from the second word through the N+1^{st} word, in the word string contained in the instructor data is an N-gram string. The N-gram is respectively called a tri-gram when N=3, a bi-gram when N=2 and a mono-gram when N=1.

For example, from the character string “Smoked trout fillet with wasabi cream”, one tri-gram string composed of the four tri-grams “Smoked trout fillet”, “trout fillet with”, “fillet with wasabi” and “with wasabi cream” is obtained. This character string is divided into a tree shape through a tag structure, as shown in FIG. 3B. Furthermore, at which words to divide this character string from a semantic standpoint is determined up to a specified height of the tree determined based on system design.

The tree structure shown in FIG. 3B branches at the position where the tags <s> and </s> are, at the position where the tags <c> and </c> are, and at the position where the tags <w> and </w> are. In the division flags, a value “1” is set when the string is divided and a value “0” is set when the string is not divided. Between what words the division flags are set is arbitrary. For example, it would be fine to define the divisions flags as only at parts where the <s> and</s> flags are, and/or the like.

The division pattern is data in which whether or not word strings are divided between words in an N-gram are defined, lining up words and division flags. For example, in the three words (word X, word Y and word Z) comprising a tri-gram, a division pattern indicating that a division cannot be made between any words, including before the word X and after the word Z, is “0 X 0 Y 0 Z 0”. A division pattern indicating divisions between all words is “1 X 1 Y 1 Z 1”.

The coefficient m/M computed from the number (M) of items of instructor data of a given N-gram, and the number (m) of items of instructor data in which the word string is divided by the division pattern of that N-gram, is a coefficient indicating the degree of the certainty of the word string being divided by that division pattern, in other words the division probability coefficient. In general, the larger the number M of instructor data items is, the more the reliability of the division probability coefficient increases.

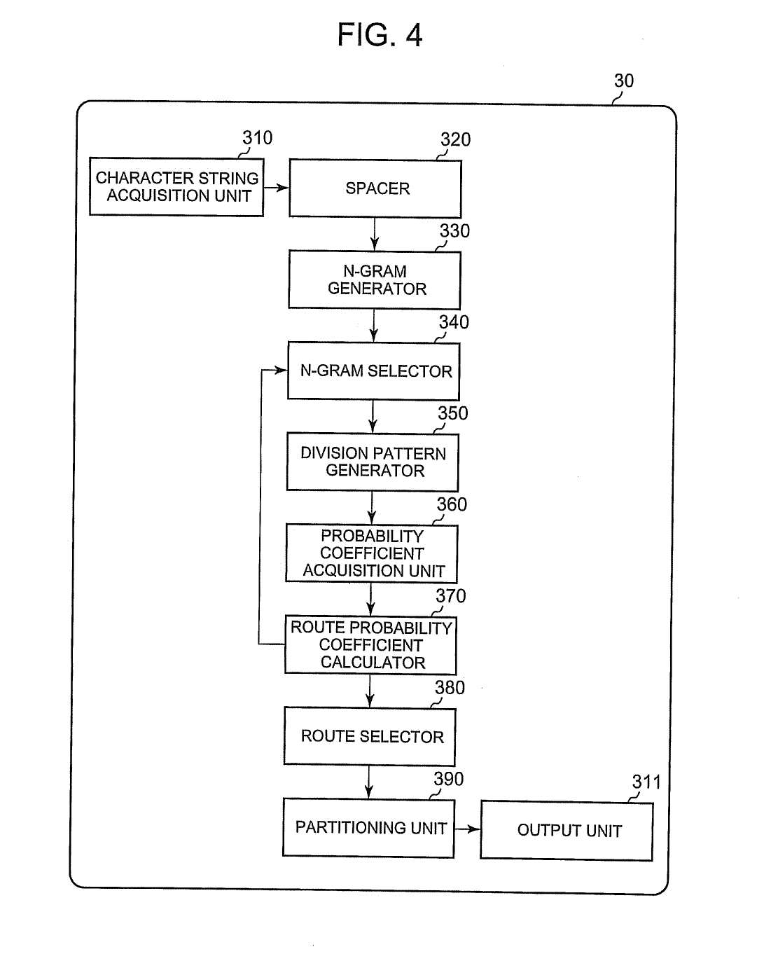

Next, the composition of the analyzer 30 is explained in greater detail. As shown in FIG. 4, the analyzer 30 is composed of a character string acquisition unit 310, a spacer 320, an N-gram generator 330, an N-gram selector 340, a division pattern generator 350, a probability coefficient acquisition unit 360, a route probability coefficient calculator 370, a route selector 380, a partitioning unit 390 and an output unit 311.

The character string acquisition unit 310 receives character strings extracted by the OCR 20 and inputs such into the spacer 320.

The spacer 320 executes a process of adding spaces to partition the character string acquired by the character string acquisition unit 310 into word units. Spacing is a way of writing that makes it easier to clearly grasp the meaning of a sentence by inserting spaces at gaps between words or gaps between phrases in languages (for example, Japanese) that are written without inserting spaces between words. The spacer 320 can execute the spacing process using an arbitrary, commonly known method for extracting words from character strings. The spacer 320 acquires a word string W by assessing intervals between words by recognizing spaces, when the character string acquired is a language in which the intervals between words are already divided with spaces, such as English or French. The spacer 320 converts the acquired character string into the word string W and inputs such into the N-gram generator 330.

When the word string W is input from the spacer 320, the N-gram generator 330 acquires an N-gram string that is a set of N-grams from the word string W. The N-gram generator 330 inputs the generated N-gram string into the N-gram selector 340. Each N-gram contained in the N-gram string is a partial string of the word string W.

The N-gram selector 340 successively selects one N-gram from among all of the input N-grams from the front of the word string W to the end, and inputs the selected N-gram into the division pattern generator 350. The order in which these are selected may be an order from the end of the character string toward the front.

When the selected N-gram is input, the division pattern generator 350 generates division patterns that can be defined in the selected N-gram. The number of division patterns is typically 2 to the (N+1) power. The division pattern generator 350 inputs the generated division patterns into the probability coefficient acquisition unit 360.

The probability coefficient acquisition unit 360 inputs the input division patterns into the probability coefficient output unit 40 and acquires division probability coefficients from the probability coefficient output unit 40. The probability coefficient acquisition unit 360 inputs division patterns and the acquired division probability coefficients into the route probability coefficient calculator 370.

The route probability coefficient calculator 370 calculates the route probability coefficient of each division pattern from the division patterns and division probability coefficients input from the probability coefficient acquisition unit 360.

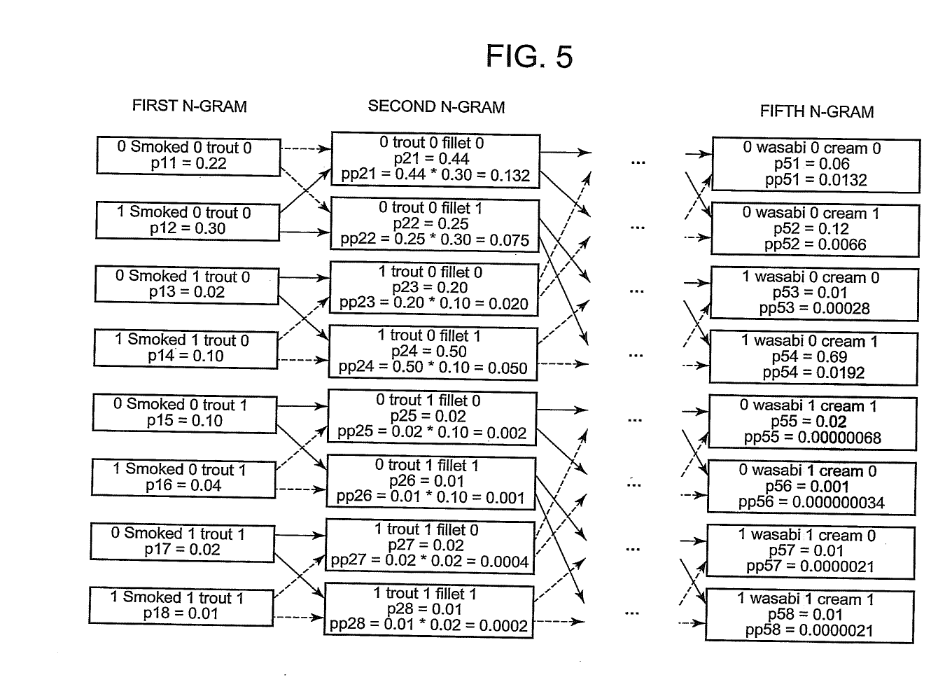

Here, the route probability coefficients calculated by the route probability coefficient calculator 370 are explained with reference to FIG. 5. The N-grams extracted from the word string W are respectively called the first N-gram, the second N-gram and so on, in order from the start of the word string W.

In FIG. 5, N=2 (bi-gram). The first N-gram is the bi-gram “Smoked trout” and the second N-gram is the bi-gram “trout fillet”. The first N-gram and the second N-gram are mutually adjacent.

Eight division patterns are defined in the first N-gram. The division probability coefficients acquired by the probability coefficient acquisition unit 360 corresponding to the division patterns defined in the first N-gram are denoted p₁₁, p₁₂, p₁₃, p₁₄, p₁₅, p₁₆, p₁₇ and p₁₈, respectively.

Eight division patterns are defined in the second N-gram. The division probability coefficients corresponding to the division patterns defined in the second N-gram are denoted p₂₁, p₂₂, p₂₃, p₂₄, p₂₅, p₂₆, p₂₇ and p₂₈, respectively.

The route probability coefficient calculator 370 determines division patterns having values in common for division flags defined between words in the division patterns corresponding to the first N-gram and division patterns corresponding to the second N-gram.

For example, in FIG. 5 the second and third division flags in the division pattern “1 Smoked 0 trout 0” corresponding to the first N-gram have the common values [0,0] with the first and second division flags in the division pattern “0 trout 0 fillet 0” and the division pattern “0 trout 0 fillet 1”, out of the eight division patterns corresponding to the second N-gram.

The route probability coefficient calculator 370 sets the product of the division probability coefficient p₂ₓ of the xth division pattern corresponding to the second N-gram and the division probability coefficient of the division pattern having a common division flag with the xth division pattern, out of the division patterns corresponding to the first N-gram, as the route probability coefficient pp₂ₓ of the xth division pattern of the second N-gram. When there are multiple division patterns having common division flags, the route probability coefficient calculator 370 selects the largest route probability coefficient pp₂ₓ.

Similarly, the route probability coefficient calculator 370 sets the product of the division probability coefficient p₃ₓ of the xth division pattern corresponding to the third N-gram and the route probability coefficient of the division pattern having a common division flag with the xth division pattern, out of the division patterns corresponding to the second N-gram, as the route probability coefficient pp₃ₓ the xth division pattern of the third N-gram.

The route probability coefficient calculator 370 makes each route probability coefficient of the division patterns of the first N-gram equal to the division probability coefficient. The route probability coefficient pp_{yx} the xth division pattern, out of the division patterns corresponding to the yth N-gram, is the product of the division probability coefficient p_{yx} and the largest value out of the route probability coefficients of the division patterns adjacent to the xth division pattern and having common division flags.

In this manner, the route probability coefficient calculator 370 calculates the route probability coefficients p_{yx} for all division patterns. A table compiling the calculated route probability coefficients is called the route probability table.

The route probability coefficient of a given division pattern indicates the degree of the certainty that the word string W is divided from a semantic standpoint by a division method indicating the most certain route (maximum likelihood route) from the first N-gram to that division pattern.

The route probability coefficient calculator 370 may find the route probability coefficients though an arbitrary numerical formula using the division probability coefficient of the division pattern on the maximum likelihood route. For example, the route probability coefficient calculator 370 may set the arithmetic mean of the division probability coefficients of the division pattern on the maximum likelihood route as the route probability coefficient. In addition, the route probability coefficient calculator 370 may find the correlation between the division probability coefficients and the route probability coefficients through experimentation, store a table in which that correlation is recorded in advance in the program memory unit 703 and obtain the route probability coefficients by referencing this table.

In this manner, the route probability coefficient calculator 370 calculates the route probability coefficient based on all division patterns contained in the N-gram. In the case in FIG. 5, the route probability coefficient calculator 370 calculates everything from the route probability coefficient pp₁₁ of the first division pattern of the first N-gram to the route probability coefficient pp₅₈ of the eighth division pattern of the fifth N-gram.

The route probability coefficient calculator 370 upon calculating the route probability coefficient associates the calculated route probability coefficient and the division pattern and inputs these into the route selection unit 380.

The route probability coefficient pp_{5y} (where y=1 to 8) indicates the degree of the certainty of the division method from a semantic standpoint showing each route from the first N-gram to the fifth N-gram. The route selection unit 380 selects the division pattern having the largest value out of the eight route probability coefficients pp₅₁ to pp₅₈ of the final (fifth) N-gram. In the example in FIG. 5, the division pattern “1 wasabi 0 cream 1” fourth (y=4) from the top is selected. Furthermore, the route selection unit 380 specifies the route (maximum likelihood route) to the selected division pattern.

That is to say, the route selection unit 380 selects the division pattern having the largest route probability coefficient out of the eight division patterns of the fourth N-gram having common division flags and being adjacent to the division pattern having the largest route probability coefficient selected in the fifth N-gram. Repeating this same process, the route selection unit 380 finds the maximum likelihood route by tracing back from the fifth N-gram to the first N-gram.

The route selection unit 380 finds the maximum likelihood route from the division patterns input from the route probability coefficient calculator 370 and the route probability coefficients thereof Furthermore, the route selection unit 380 selects the division pattern on the maximum likelihood route from among the division patterns generated by the division pattern generator 350. The route selection unit 380 inputs the selected division pattern into the word string partitioning unit 390.

The word string partitioning unit 390 partitions the word string W by a division method indicating the division patterns input from the route selection unit 380. The division method expressed by the division patterns on the maximum likelihood route is determined to be the suitable division method from the standpoint of the semantics of the word string W. Furthermore, the word string partitioning unit 390 inputs the partitioned word string into the output unit 311.

The output unit 311 inputs the partitioned word string into the converter 50.

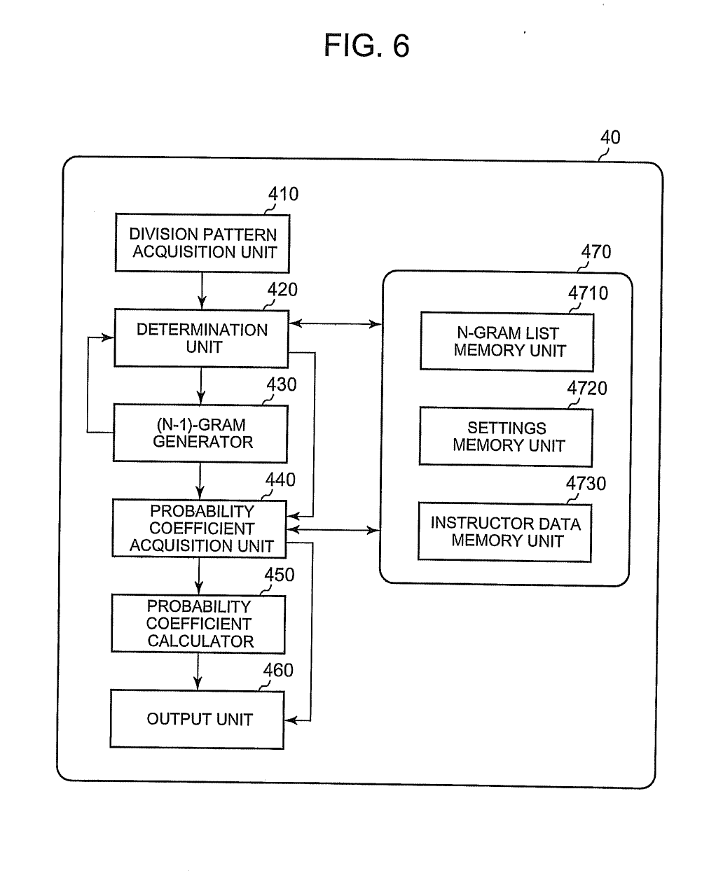

Next, the composition of the probability coefficient output unit 40 is described in detail. As shown in FIG. 6, the probability coefficient output unit 40 is composed of a division pattern acquisition unit 410, a determination unit 420, an (N−1)-gram generator 430, a probability coefficient acquisition unit 440, a probability coefficient calculator 450, an output unit 460 and a memory unit 470.

The division pattern acquisition unit 410 acquires a division pattern from the analyzer 30. The division pattern comprises words contained in an N-gram and division flags corresponding to spaces between words. The division pattern acquisition unit 410 inputs the acquired division pattern into the determination unit 420.

The determination unit 420 determines whether or not the above-described division probability coefficients on all of the division patterns of the N-gram input from the division pattern acquisition unit 410 can be acquired based on the instructor data of the N-gram. In this determination process, the determination unit 420 references an N-gram list stored in an N-gram list memory unit 4710 of the memory unit 470. Specific details of this N-gram list and the determination process executed by the determination unit 420 are described below.

When it is determined that the N-gram division probability coefficients can be acquired, the determination unit 420 inputs the N-gram into the probability coefficient acquisition unit 440. On the other hand, when it is determined that the N-gram division probability coefficients cannot be acquired, the determination unit 420 inputs the N-gram into the (N−1)-gram generator 430.

When the N-gram is input from the determination unit 420, the (N−1)-gram generator 430 generates a first (N−1)-gram composed of the first through the N−1^{st} words comprising the N-gram, and a second (N−1)-gram composed of the second through the Nth words. The (N−1)-gram generator 430 inputs the two generated (N−1)-grams into the determination unit 420.

When the two (N−1)-grams are input from the (N−1)-gram generator 430, the determination unit 420 determines whether or not the division probability coefficients can be acquired based on the instructor data of the (N−1)-grams, for the two (N−1)-grams, respectively. When a division probability coefficient cannot be acquired from either of the two (N−1)-grams, the determination unit 420 causes three (N−2)-grams to be generated by the (N−1)-gram generator 430 and determines whether or not a division probability coefficient can be acquired. If a division probability coefficient cannot be acquired, the same determination process is repeated until arriving at mono-grams. Specific details of the processes executed by the determination unit 420 and the (N−1)-gram generator 430 are described below. When mono-grams are input from the (N−1)-gram generator 430, the determination unit 420 inputs those mono-grams into the probability coefficient acquisition unit 440 without executing the determination process.

When the division pattern acquired by the division pattern acquisition unit 410 is input from the determination unit 420, the probability coefficient acquisition unit 440 acquires the division probability coefficient of that division pattern and inputs such into the output unit 460.

On the other hand, when an (N−1)-gram is input, the probability coefficient acquisition unit 440 generates the division patterns of the (N−1)-grams necessary for acquiring the division probability coefficients of the division patterns acquired by the division pattern acquisition unit 410, and acquires division probability coefficients for the generated division patterns.

The probability coefficient acquisition unit 440 inputs the (N−1)-gram, the generated division patterns, and the division probability coefficients thereof into the probability coefficient calculator 450. The probability coefficient acquisition unit 440 acquires the division probability coefficients of the (N−1)-grams by referencing the instructor data stored in an instructor data memory unit 4730. Specific process details for the probability coefficient acquisition unit 440 acquiring the division probability coefficients are described below.

When the division patterns generated from the (N−1)-grams and the division probability coefficients thereof are input from the probability coefficient acquisition unit 440, the probability coefficient calculator 450 calculates the division probability coefficients of each division pattern of the N-gram. The probability coefficients of the N-gram is calculated from the probability coefficients of the (N−1)-gram. The calculation process by which the probability coefficient calculator 450 calculates the division probability coefficients is described below. The probability coefficient calculator 450 inputs the calculated division patterns of the N-gram and the division probability coefficients thereof into the output unit 460.

The output unit 460 outputs the division probability coefficient and the division patterns input from the probability coefficient calculator 450 into the analyzer 30.

The memory unit 470 stores data input from the various parts and setting parameters and/or the like necessary for processes accomplished by the probability coefficient output unit 40. In addition, the memory unit 470 outputs data stored in response to commands to read data from the various parts.

The memory unit 470 includes an N-gram list memory unit 4710 for storing N-gram lists, a settings memory unit 4720 for storing setting parameters used when the probability coefficient output unit 40 executes the below-described process, and an instructor data memory unit 4730 for storing instructor data.

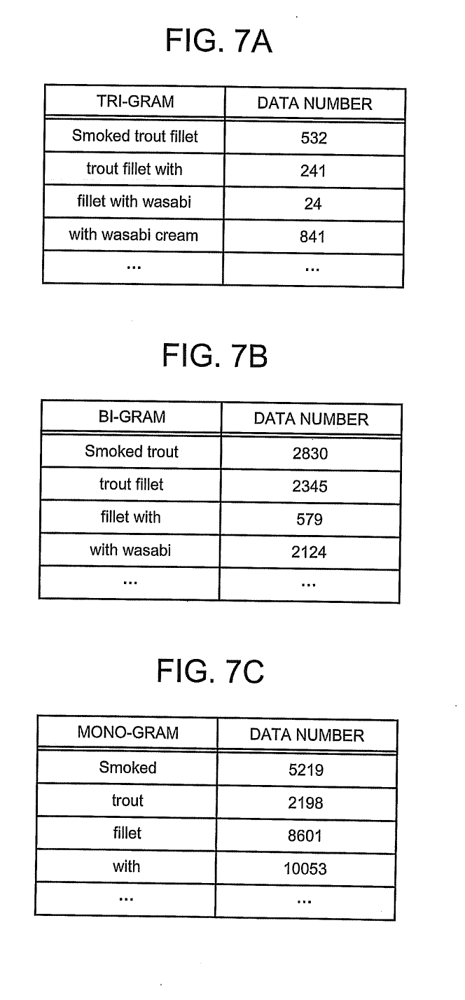

All N-grams corresponding to instructor data stored in the instructor data memory unit 4730 are recorded in the N-gram list. Examples of N-gram lists stored in the N-gram list memory unit 4710 are shown in FIGS. 7A, 7B and 7C. For example, the N-gram memory unit 4710 stores the tri-gram list shown in FIG. 7A, the bi-gram list shown in FIG. 7B and the mono-gram list shown in FIG. 7C.

The tri-gram list correlates tri-grams and the number of items of instructor data corresponding to those tri-grams. The bi-gram list and mono-gram list are similar.

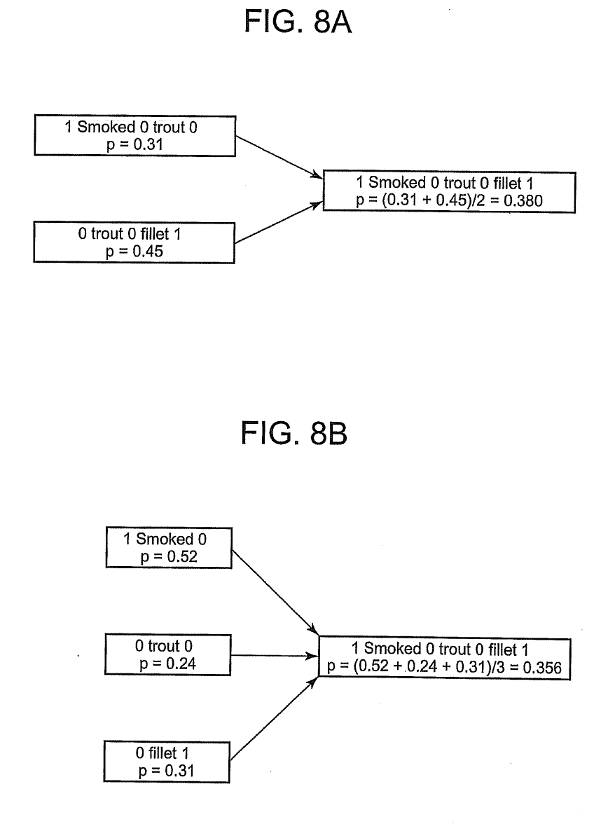

Next, the process by which the probability coefficient calculator 450 calculates the division probability coefficients of the division patterns of the N-grams using the division probability coefficients of the division patterns of the (N−1)-grams is explained with reference to FIG. 8. The probability coefficient calculator 450 can calculate the division probability coefficients of N-grams similarly using the division probability coefficients of (N−2)-grams, (N−3)-grams, mono-grams and/or the like.

When a given tri-gram is not recorded in the tri-gram list shown in FIG. 7A, or when the instructor data exceeding a prescribed threshold value is not recorded, the probability coefficient calculator 450 can calculate the probability coefficients of the division patterns of the tri-gram from the division probability coefficients of the division patterns of the bi-grams and mono-grams.

The calculation process by which the probability coefficient calculator 450 calculates the division probability coefficient of the division pattern “1 Smoke 0 trout 0 fillet 1” of the tri-gram “Smoked trout fillet” is explained with reference to FIG. 8A.

The first bi-gram contained in the tri-gram “Smoked trout fillet” is “Smoked trout”, and the second bi-gram is “trout fillet”. The second and third values out of the values [1, 0, 0] of the division flags in the first bi-gram division pattern “1 Smoked 0 trout 0”, and the first and second values out of the values [0, 0, 1] of the division flags in the second bi-gram division pattern “0 trout 0 fillet 1”, are the common values [0, 0].

When the bi-gram division patterns and the division probability coefficients thereof are acquired from the probability coefficient acquisition unit 440, the probability coefficient calculator 450 compares the division flags and extracts division patterns that are adjacent and also have common division flags. Furthermore, the probability coefficient calculator 450 sets the values found from the arithmetic mean of the respective division probability coefficients as the division probability coefficient of the tri-gram division pattern. That is to say, the tri-gram division probability coefficients are obtained from the bi-gram division probability coefficients.

Similarly, when the mono-gram division patterns and the division probability coefficients thereof are acquired from the probability coefficient acquisition unit 440, the probability coefficient calculator 450 extracts division patterns that are adjacent and also have common division flags and sets the values found from the arithmetic mean of the respective division probability coefficients as the division probability coefficient of the tri-gram division pattern. That is to say, the tri-gram division probability coefficients are obtained from the mono-gram division probability coefficients.

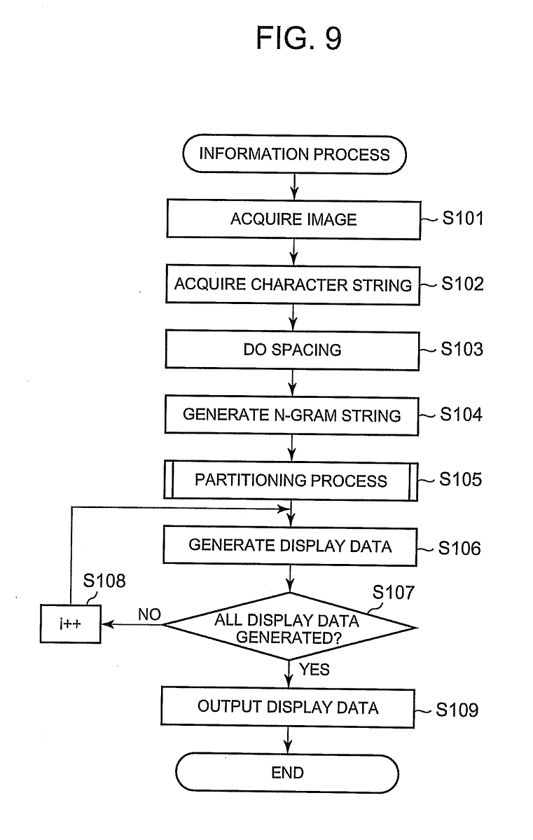

Next, details of the information process executed by the information processing unit 70 are described with reference to the flowcharts in FIGS. 9, 10, 11 and 12. The information processing device 1 starts this information process when the image input unit 10 shoots a subject (for example, a menu written on restaurant paper) under instructions from the user.

First, the image input unit 10 acquires an image of the subject (step S101). The OCR 20 recognizes characters in the acquired image and acquires a character string (step S102).

When the OCR 20 acquires the character string and inputs such into the analyzer 30, the spacer 320 executes a spacing program that divides the character string into word units, converting the character string into a word string W (step S103). When multiple character strings are acquired, the spacer 320 executes spacing on each of the acquired character strings.

The N-gram string generator 330 generates N-gram strings from the word string W (step S104). In this preferred embodiment, N=2 (bi-grams).

The analyzer 30 executes a partition process partitioning the word string W by estimating at what positions the word string W can be divided (step S105).

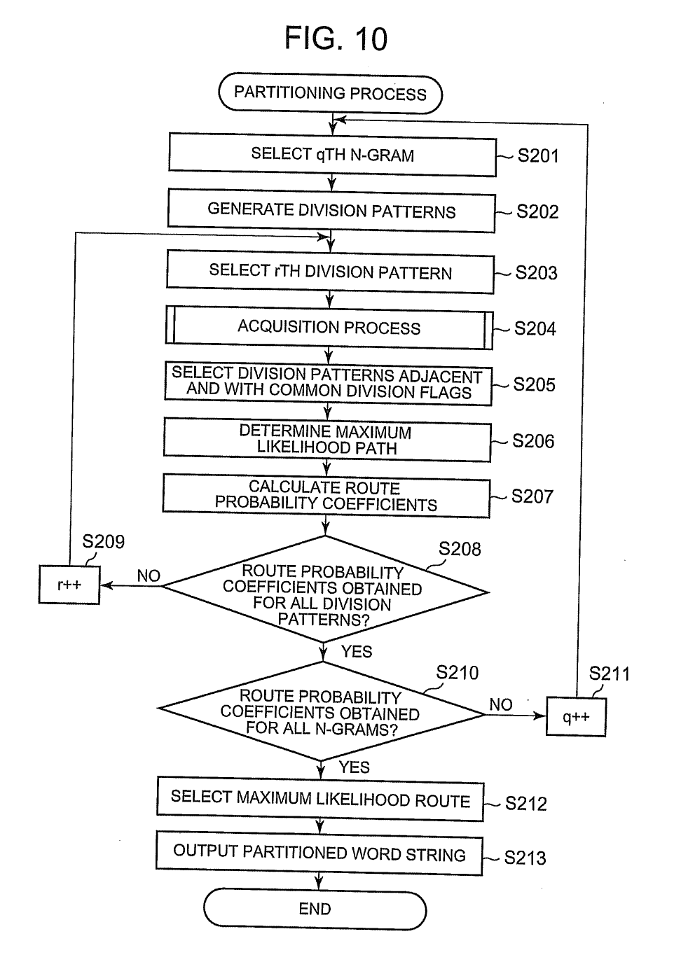

The partitioning process executed in step S105 is explained with reference to FIG. 10. First, the N-gram selector 340 defines a counter variable “q” and selects the qth N-gram of the N-gram string (step S201). The initial value of the counter variable q is 1, and this value is incremented by 1 each time the process is looped.

Next, the division pattern generator 350 generates division patterns of the selected N-gram (step S202). In this preferred embodiment, 2 to the (N+1) power=8 division patterns are generated. The division pattern generator 350 generates a route probability table from the generated division patterns.

Next, the division pattern generator 350 defines a counter variable “r” and selects the rth division pattern out of the division patterns generated in step S202 (step S203). The initial value of the counter variable r is 1 and this value is incremented by 1 each time the process is looped.

The probability coefficient acquisition unit 360 inputs the selected division pattern into the probability coefficient output unit 40. The probability coefficient output unit 40 executes an acquisition process to acquire the division probability coefficient p_{qr} of the selected division pattern (step S204).

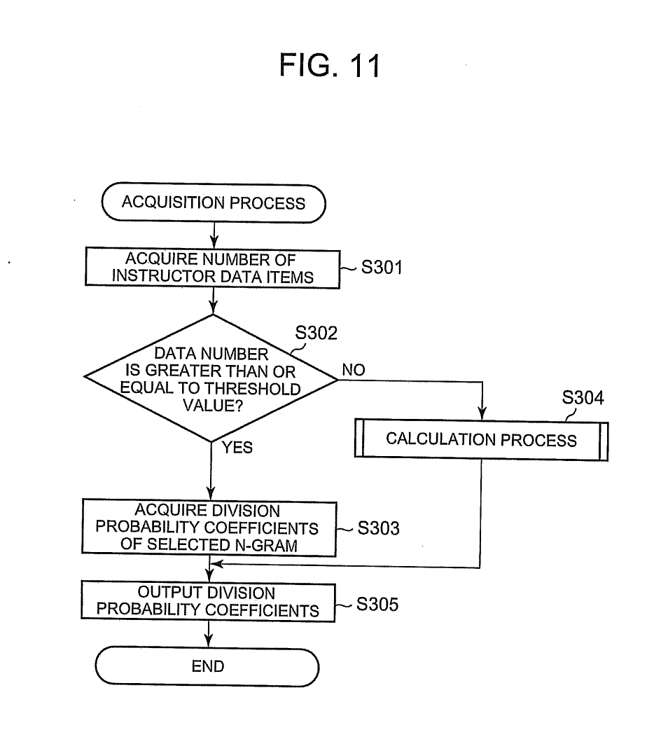

The acquisition process executed in step S204 is explained with reference to FIG. 11. When the division pattern acquisition unit 410 acquires the N-grams and division patterns from the analyzer 30, the probability coefficient output unit 40 starts the acquisition process.

First, the determination unit 420 acquires the number of data items of instructor data of the N-gram selected in step S201 with reference to the N-gram lists stored in the N-gram list memory unit 4710 (step S301).

The determination unit 420 determines whether or not a sufficient number of instructor data items exist for finding the division probability coefficients, by comparing the number of items of instructor data and a threshold value stored in advance in the settings memory unit 4720.

When the number of data items is at least as great as the threshold value (step S302: Yes), the probability coefficient acquisition unit 440 acquires the division probability coefficients of the division patterns of the selected N-gram (step S303). That is to say, it is determined that the number of instructor data items is large enough for results to be obtained with sufficient confidence.

Specifically, the probability coefficient acquisition unit 440 extracts the instructor data corresponding to the selected N-grams that is instructor data stored in the instructor data memory unit 4730. The number of instructor data items extracted at this time is n1. The probability coefficient acquisition unit 440 extracts instructor data having a common division method based on the division flags in the extracted instructor data and the division flags in the division patterns of the selected N-grams. The number of instructor data items extracted at this time is n2.

The division probability coefficient p is found by comparing n1 and n2:

p=n2/n1 [Equation 1]

The method of finding the division probability coefficient p is not limited to this. It is possible to find the value of p using an arbitrary equation such that the value of p becomes larger the larger the value of n2 becomes, and becomes smaller the larger the value of n1 becomes. For example, it is possible to use the following Equation 2:

p=n2̂2/(n1̂2) [Equation 2]

Here, the operator “̂” indicates an exponent.

On the other hand, when the number of instructor data items is smaller than the threshold value, or when instructor data has not been recorded (step S302: No), the probability coefficient acquisition unit 440 executes a calculation process for calculating the division probability coefficients of the N-gram using (N−1)-grams, (N−2)-grams and/or the like (step S304).

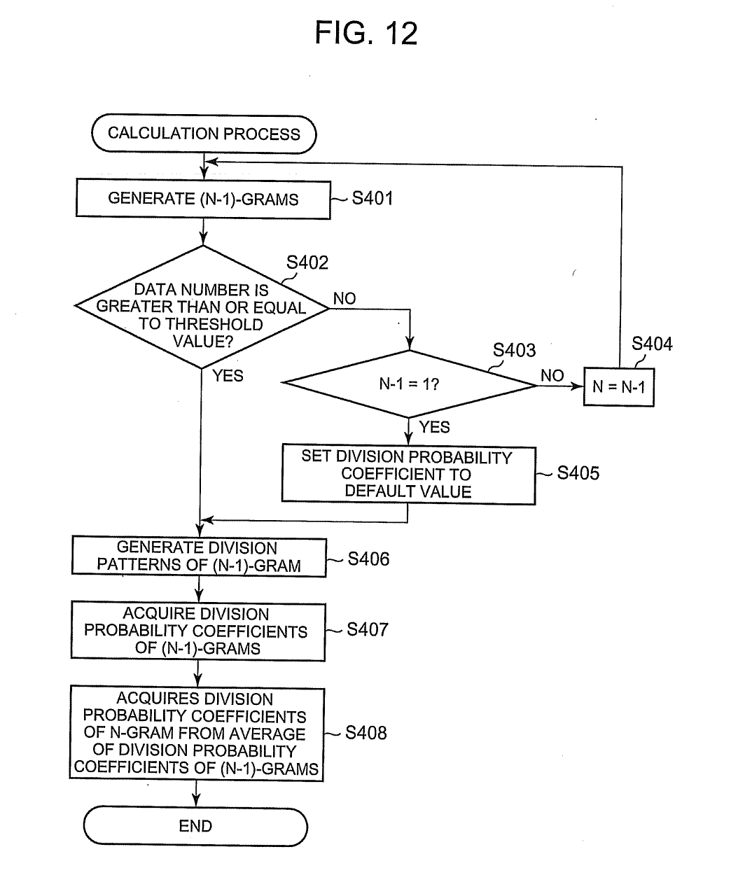

The calculation process executed in step S304 is explained with reference to FIG. 12. First, the (N−1)-gram generator 430 generates two (N−1)-grams that are partial strings of the selected N-gram (step S401).

The determination unit 420 determines whether or not acquisition of the division probability coefficients is possible based on the instructor data of the (N−1)-grams, for both of the (N−1)-grams, based on the (N−1)-gram list stored in the N-gram list memory unit 4710, the same as in step S302 of the acquisition process in FIG. 8. That is to say, the determination unit 420 compares the number of instructor data items with a prescribed threshold value for each of the two (N−1)-grams (step S402).

Here, the threshold value can be arbitrarily set, but is preferably a larger threshold value the larger N is. The number of division patterns that can be defined from an N-gram is 2̂(N+1), so as N becomes larger, the increase in the number of division patterns that can be defined becomes larger. In order to acquire division probability coefficients with higher confidence, it is desirable for the number of instructor data items to be larger the larger the number of division patterns.

When the number of instructor data items in both (N−1)-grams is greater than or equal to the threshold value (step S402: Yes), the process moves to step S406 in order for the probability coefficient calculator 450 to calculate the division probability coefficients of the N-gram using the division probability coefficients of the (N−1)-grams.

When the number of instructor data items of either (N−1)-gram is less than the threshold value (step S402: No), the probability coefficient calculator 450 calculates the probability coefficients using (N−2)-grams. That is to say, the determination unit 420 determines whether or not N−1 is 1, in other words whether or not the (N−1)-grams are mono-grams (step S403). When N−1 is not 1 (step S403: No), the (N−1)-gram generator 430 decrements N by 1 (step S404) and returns to step S401 to generate (N−1)-grams.

On the other hand, when N−1 is 1 (step S403: Yes), in other words when the (N−1)-grams are mono-grams, it is not possible to reduce N any further, so the probability coefficient calculator 450 sets the division probability coefficients of the division patterns of the (N−1)-grams to a default value (for example, 0.5) (step S405).

The probability coefficient calculator 450 generates division patterns having division flags in common with the division patterns input from the analyzer 30 (step S406). Furthermore, the probability coefficient calculator 450 acquires the division probability coefficients of each division pattern generated, the same as in step S303 (step S407).

Furthermore, the probability coefficient calculator 450 sets the average of the division probability coefficients of the division patterns of the obtained (N−1)-grams as the division probability coefficients of the division pattern of the N-gram (step S408). Through this calculation process, the division probability coefficients of all division patterns are obtained.

Returning to FIG. 11, when the division probability coefficients are acquired in step S303 or step S304, the output unit 460 outputs the acquired division probability coefficients to the analyzer 30 (step S305).

Returning to FIG. 10, when the division probability coefficient p_{qr} of the division pattern is acquired in step S204, the route probability coefficient calculator 370 extracts divisions patterns adjacent to the selected division pattern and having common division flags (step S205).

Next, the route probability coefficient calculator 370 determines out of the extracted division patterns that the route to the selected division pattern from the division pattern having the larger route probability coefficients is the maximum likelihood route (step S206).

Furthermore, the route probability coefficient calculator 370 calculates the route probability coefficient pp_{qr} by multiplying the route probability coefficient of the division pattern of the maximum likelihood path selected in step S206 with the division probability coefficient of the division pattern acquired in step S204 (step S207).

When the route probability coefficient pp_{qr} is calculated in step S207, the information processing unit 70 determines whether or not the route probability coefficient pp_{qr} has been calculated for all division patterns of the qth N-gram (step S208). In the example in FIG. 5, the determination is whether or not the route probability coefficients (pp_{q1}, to pp_{q8}) of the eight division patterns generated for the qth N-gram have all been calculated.

When it is determined that there are division patterns for which the route probability coefficient pp_{qr} has not be calculated among all of the division patterns of the qth N-gram (step S208: No), the information processing unit 70 increments the counter variable r (step S209) and repeats the process from step S203 to step S208.

On the other hand, when it is determined that the route probability coefficient pp_{qr} has been calculated for all division patterns of the qth N-gram (step S208: Yes), the information processing unit 70 determines whether or not the route probability coefficients have been calculated for the division patterns of all of the N-grams generated in step S104 (step S210). When it is determined that there is a division pattern for which the route probability coefficients have not been calculated among all of the division patterns of the N-grams (step S210: No), the counter q is incremented (step S11) and the process from steps S201 to S210 is repeated.

On the other hand, when it is determined that the route probability coefficients of all N-grams have been calculated (step S210: Yes), the route selector 380 selects the largest route probability coefficient from among the division patterns of the last N-gram (the fifth N-gram in the example in FIG. 5). In the example in FIG. 5, the route probability coefficient pp₅₄ is selected. Furthermore, the route selector 380 traces the route backwards and selects the route linked to the division pattern in which the route probability coefficient pp₅₄ is large, that is to say the maximum likelihood route (step S212).

When the division pattern on the maximum likelihood route is selected in step S212, the word string partitioning unit 390 partitions the word string W using the division method of the selected division pattern, and outputs the partitioned word string to the converter 50 (step S213).

Returning to FIG. 9, when the word string W acquired in step S103 is partitioned into multiple words in the partitioning process (step S105), the converter 50 defines a counter variable “i”, acquires explanatory data of the ith word from the dictionary memory unit 60 and generates display data such as that shown in FIG. 2C (step S106).

The converter 50 determines whether or not display data was generated for all words obtained in step S105 (step S107). If it is determined that there is display data that has not yet been generated (step S107: No), the converter 50 increments the counter i (step S108) and again generates display data.

On the other hand, when it is determined that display data has been generated for all words (step S106: Yes), the display unit 80 displays the obtained display data (step S109) and information processing concludes.

As described above, with the information processing device 1 according to this preferred embodiment, it is possible to partition character strings contained in a photographed image so as to have an appropriate meaning, based on instructor data. A syntax analysis algorithm may be prepared for each language.

In addition, because the division probability coefficients of the division patterns and the division probability coefficients of the division patterns that are division patterns adjacent thereto and have common division flags are considered together, the precision of partitioning the word string W is higher than when the division pattern having the largest division probability coefficients is simply selected from among the division patterns of the N-grams.

In addition, by generating instructor data from character strings belonging to prescribed categories (a food menu in this preferred embodiment), it is possible to increase the precision of partitioning the word string W more than using instructor data belonging to all categories. Naturally, it is possible to using the information processing device 1 for translation and analysis of character strings belonging to other categories, but in this case, it is preferable to prepare in advance instructor data suitable for each application.

With the information processing device 1 according to this preferred embodiment, it is possible to photograph using the image input unit 10, to recognize and analyze character strings using the OCR 20 and to display the analysis results. The information processing device 1 can photograph, incorporate character strings and display explanatory data even without the user painstakingly inputting by hand character strings written on the subject. Even when the food menu included in the subject is written in an unknown language and inputting by keys is difficult, the user can cause the meaning of those character strings to be displayed on the information processing device 1. Furthermore, by generating explanatory data in multiple languages, the information processing device 1 can be comprised as a translation device.

With this preferred embodiment, only one division pattern of a route with the largest route probability coefficients is selected, the word string W is partitioned using the division method indicated by that division pattern, and the partition results are displayed. However, it would also be fine for the word string W to be partitioned using multiple division methods whose route probability coefficients satisfy prescribed conditions (for example, at least as great as a threshold value) and for these multiple partition results to be displayed. Through this, it is possible to display and present to the user multiple explanatory data candidates having a high possibility of meanings matching, so that even if the maximum likelihood route is in error, the possibility of the correct explanatory data being presented to the user increases.

In addition, with this preferred embodiment, when the instructor data of the N-grams is small in number or does not exist, it is possible to find the division probability coefficients of the division patterns of the N-grams from instructor data such as from (N−1)-grams, grams, (N−2)-grams and/or the like. Consequently, the number of instructor data items that should be prepared in advance is reduced.

In addition, because it is possible to calculate the division probability coefficients of the division patterns of the N-grams based on the division probability coefficients of the division patterns of the (N−1)-grams and/or the like whose division flags match, the precision of the calculation results are higher than determining the division method using only word commonality.

In addition, when the information processing device 1 calculates the division probability coefficients of the N-grams from the division probability coefficients of the two (N−1)-grams, there is no deviation in handling the two (N−1)-grams, so the division probability coefficients of one of the (N−1)-grams does not have a stronger effect on the calculation results.

### Second Embodiment

In the above-described first preferred embodiment, when the division probability coefficient of the N-gram was obtained from the division probability coefficients of the (N−1)-grams, the average value of the division probability coefficients of the division patterns with common division flag values was used as the division probability coefficient of the N-gram, but the method of finding the division probability coefficients of the N-grams is not limited to this.

For example, the information processing device 1 may apply an arbitrary weighting to the division probability coefficients of the (N−1)-grams. In addition, this need not be a simple average, but may be an exponential average.

The information processing device 1 may set a prescribed maximum value (for example, 0.8) to the division probability coefficients. Furthermore, the information processing device 1 may set this prescribed maximum value as the division probability coefficients when the calculated division probability coefficients exceed the prescribed maximum value.

The information processing device 1 may store tables linking the division probability coefficients of the (N−1)-grams and the division probability coefficients of the N-gram calculated from those (N−1)-grams in the memory unit 470 in advance, and instead of calculating each time may find the division probability coefficients of the N-gram by referencing this table.

In the above-described first preferred embodiment, the information processing device 1 extracted the word string W from an image shot by the image input unit 10, but the information processing device 1 may extract the word string W from a character string input by the user using a keyboard. In addition, the information processing device 1 may acquire the word string from audio data through voice recognition.

In the above-described first preferred embodiment, the display data was created using explanatory data recorded in the dictionary for each word, but the method of creating the display data is not limited to this. For example, the information processing device 1 may translate the partitioned word string W using an arbitrary translator on each fragment, and make the translation results the display data. For example, a user who can understand Japanese but cannot understand Chinese can peruse a translation into Japanese through the operation of photographing the character string, even if inputting Chinese using a keyboard is impossible.

The information processing device 1 may search a dictionary database prepared in advance using each fragment comprising the word string as a search key, and may display those search results. For example, when the partitioned fragments are “wasabi” and “cream”, the explanatory data for “wasabi” and “cream” can be displayed separately or the explanatory data for the combination “wasabi cream” can be displayed. In addition, the information processing device 1 may using the partitioned fragments as search keys to do an image search and display images obtained.

In addition, the word string W that is the target of analysis is not limited to a food menu. For example, besides a menu this may be an address, a pharmaceutical efficacy statement, a machine's instruction book, software specifications and/or the like.

In the above-described first preferred embodiment, the information processing device 1 executes no special processes for the start or end of the word string W. However, the information processing device 1 may execute the above-described information process by posting a symbol (BOS: Begin of Sentence) indicating the start, at the start of the word string W, and posting a symbol (EOS: End of Sentence) indicating the end, at the end of the word string W. In this case, the instructor data is data that posts BOS at the start of the word string W and posts EOS at the end. In addition, when generating N-gram strings the N-gram string generator 330 may generate an N-gram string with BOS posted at the start and EOS posted at the end. Through this, the information processing device 1 can estimate the division method for the word string W taking into consideration the position of the start or end of the word string W, and can divide the word string W with high precision.

With the above-described first preferred embodiment, the instructor data is stored in the memory unit 470, but the instructor data may be stored in an external device different from the information processing device 1, and the information processing device 1 may acquire the instructor data from the external device via a communications network as necessary using a communication unit 705.

The information processing device 1 may find the division probability coefficients one-by-one, but an external device that can communicate with the information processing device 1 may store in advance a probability coefficient list in which division probability coefficients are recorded. The information processing device 1 may acquire this probability coefficient list from an external server and acquire the division probability coefficients.

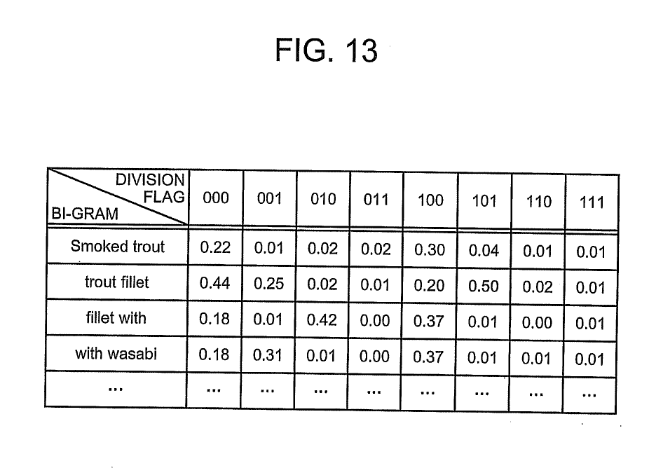

An example of a probability coefficient list is shown in FIG. 13. For example, in the column of pattern “000” and the row of the bi-gram “Smoked trout”, the value 0.22 is recorded, and this shows that the division probability coefficient of the division pattern “0 Smoked 0 trout 0” is 0.22. The information processing device 1 stores the various probability coefficient lists for N-grams, (N−1)-grams, (N−2)-grams, mono-grams and/or the like in the data memory unit 702, and can acquire the division probability coefficients with reference to these.

The method of searching for a route to indicate the division method is not limited to the above-described method. For example, it is possible to use a route search method in which the route probability coefficients are handled the same as distance to search for a route whose distance is longest (or at least a threshold value), or whose distance is shortest (or not greater than a threshold value).

The character string acquisition unit 310 may execute the above-described information process strictly differentiating upper-case characters and lower-case characters when upper-case characters and lower-case characters from an alphabet are intermixed in the word string W, and may execute the above-described information process by converting everything to lower-case characters or by converting everything to upper-case characters.

### Third Embodiment

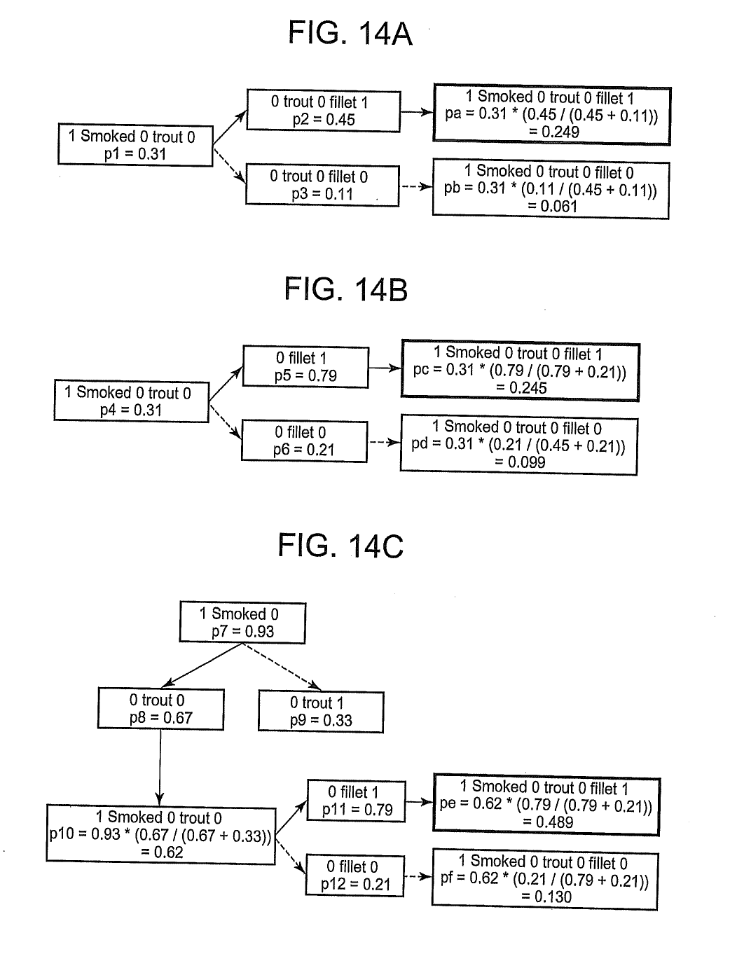

Next, the third preferred embodiment of the present invention is explained. The hardware composition of the information processing device 1 according to the third preferred embodiment is the same as for that shown in the above-described first preferred embodiment. The method of calculating the division probability coefficients accomplished by the probability coefficient output unit 40 in this preferred embodiment differs from the first preferred embodiment. The method of calculating the division probability coefficients accomplished by the probability coefficient output unit 40 of this preferred embodiment is explained with reference to FIGS. 14A, 14B and 14C.

As described above, when a sufficient number of instructor data items for the N-gram are not stored in the memory unit 470, the probability coefficient output unit 40 creates the division patterns of the N-gram based on the instructor data of the (N−1)-grams instead of calculating the division probability coefficients based on the division patterns of the N-gram, and then calculates the division probability coefficients.

For example, when the instructor data of the division pattern “1 Smoked 0 trout 0 fillet 1” of the tri-gram “Smoked trout fillet” cannot be acquired from the memory unit 470, the probability coefficient output unit 40 acquires the division patterns of the first bi-gram “Smoked trout” and the second bi-gram “trout fillet” obtained from that tri-gram. As shown in FIG. 14A, the probability coefficient output unit 40 selects the division pattern “1 Smoked 0 trout 0” (division probability coefficient p1) having division flags common with the tri-gram, from among the division patterns of the first bi-gram. In addition, the probability coefficient output unit 40 extracts the two division patterns “0 trout 0 fillet 1” (division probability coefficient p2) and “0 trout 0 fillet 0” (division probability coefficient p3) adjacent to the division pattern selected from the first bi-gram and having common division flags.

The probability coefficient output unit 40 finds the probability pa that the division pattern “0 trout 0 fillet 1” comes after the division pattern “1 Smoked 0 trout 0” through Equation 3:

pa=p1*(p2/(p2+p3)) [Equation 3]

In place of Equation 3, the probability coefficient output unit 40 may use Equation 4:

pa=p1̂2*(p2̂2/(p2+p3)̂2) [Equation 4]

The probability coefficient output unit 40 is not limited to Equation 3 and Equation 4, and can calculate the division probability coefficients using an arbitrary equation.

In addition, a table pre-corresponding the division probability coefficients of the division patterns of the first (N−1)-gram, the division probability coefficients of the second (N−1)-gram and the calculated values of the division probability coefficients of the division patterns of the N-gram may be stored in the memory unit 470, and the probability coefficient output unit 40 may find the division probability coefficients of the N-gram by referencing this table without using equations such as Equation 3, Equation 4 and/or the like.

Or, when the instructor data of the tri-grams cannot be acquired from the memory unit 470, the probability coefficient output unit 40 can calculate the division probability coefficients of the tri-gram from the division patterns of one bi-gram contained in the tri-gram and the division patterns of one monogram contained in the tri-gram.

That is to say, as shown in FIG. 14B, the probability coefficient output unit 40 acquires the division pattern “1 Smoked 0 trout 0” (division probability coefficient p4) which is a division pattern of the bi-gram “Smoked trout” obtained from this tri-gram and has division flags common with the tri-gram, and in addition acquires the division patterns “0 fillet 1” (division probability coefficient p5) and “0 fillet 0” (division probability coefficient p6) that are division patterns of the mono-gram “fillet” obtained from this tri-gram, are adjacent to this bi-gram and share common division flags.

The probability coefficient output unit 40 finds the probability pc that the division pattern “0 fillet 1” comes after the division pattern “1 Smoked 0 trout 0” from Equation 5:

pc=p4*(p5/(p5+p6)) Equation 5

Furthermore, when the probability coefficient output unit 40 cannot acquire the instructor data for the tri-gram “Smoked trout fillet” from the memory unit 470, the probability coefficient output unit 40 can calculate the division probability coefficients from the division patterns of the three mono-grams contained in the tri-gram.

That is to say, as shown in FIG. 14C, the probability coefficient output unit 40 acquires the division pattern “1 Smoked 0” (division probability coefficient p7) of the first mono-gram “Smoked” obtained from this tri-gram and in addition acquires the two division patterns “0 trout 0” (division probability coefficient p8) and “0 trout 1” (division probability coefficient p9) that are the division patterns of the second mono-gram “trout” obtained from this same tri-gram and also are adjacent to the first mono-gram and share common division flags.

The probability coefficient output unit 40 finds the probability pd that the division pattern “0 trout 0” comes after the division pattern “1 Smoked 0” from Equation 6:

pd=p7*(p8/(p8+p9)) Equation 6

Furthermore, the probability coefficient output unit 40 acquires the two division patterns “0 fillet 1” (division probability coefficient p11) and “0 fillet 0” (division probability coefficient p12) that are adjacent to the division pattern “1 Smoked 0 trout 0” (division probability coefficient p10) and share common division flags.

The probability coefficient output unit 40 finds the probability pe that the division pattern “0 fillet 1” comes after the division pattern “1 Smoked 0 trout 0” from Equation 7:

pe=p10*(p11/(p11+p12)) Equation 7

As shown in FIGS. 14A, 14B and 14C, the probability coefficient output unit 40 can calculate the division probability coefficients of the N-gram based on the division probability coefficients of the (N−1)-grams and/or the (N−2)-grams using Equations 3 through 7 when the instruction data for the N-gram is small in number or is not stored in the memory unit 470.

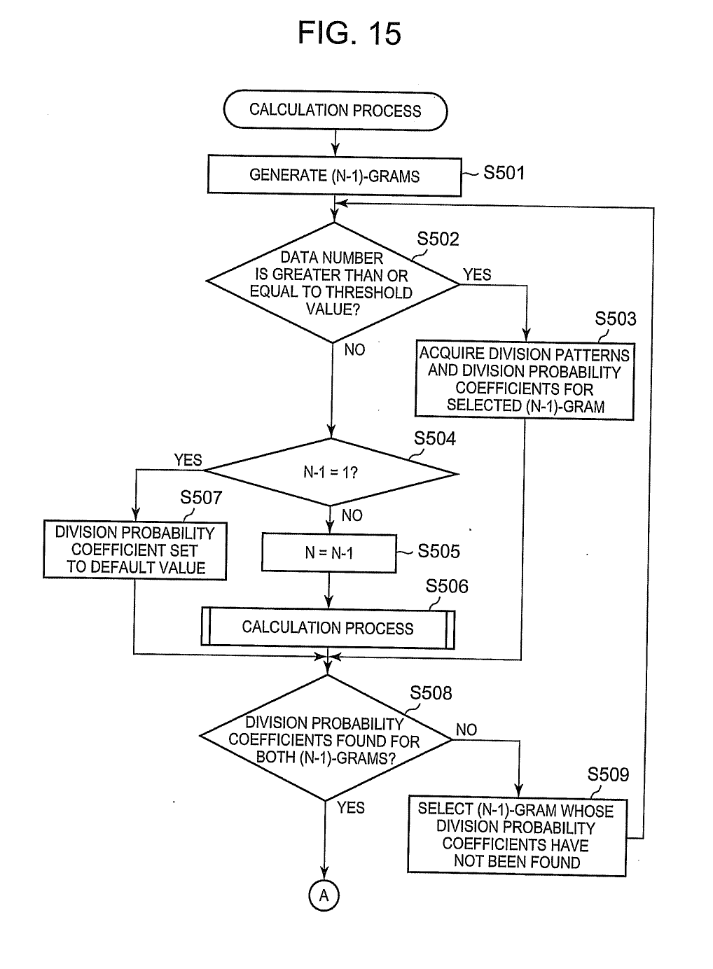

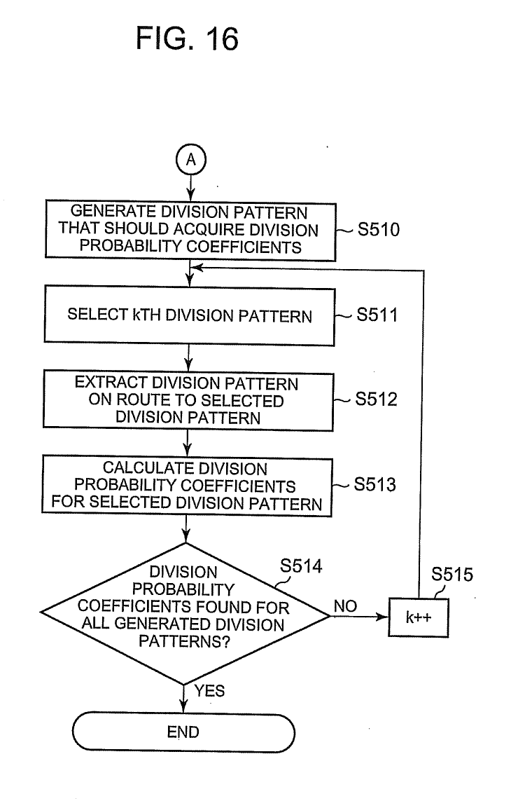

Next, the calculation process executed by the probability coefficient output unit 40 in this preferred embodiment is explained in greater detail using the flowcharts in FIGS. 15 and 16.

When the user inputs instructions to photograph a subject, the information processing device 1 of this preferred embodiment executes the information process of FIG. 9, the partitioning process of FIG. 10 and the acquisition process of FIG. 11, the same as the first preferred embodiment. In step S304 of the acquisition process, the probability coefficient output unit 40 executes the calculation process shown in FIG. 15 in place of the calculation process shown in FIG. 12.

First, the (N−1)-gram generator 430 generates the two (N−1)-grams contained in the selected N-gram (step S501), and selects the (N−1)-gram closer to the start of the character string W.

Next, the determination unit 440 determines whether or not the number of instructor data items for the division patterns of the selected (N−1)-gram is greater than or equal to a prescribed value (step S502).

When the number of instructor data items of the selected (N−1)-gram is greater than or equal to the prescribed threshold value (step S502: Yes), the probability coefficient acquisition unit 440 acquires the division patterns and division probability coefficients of the selected (N−1)-gram (step S503).

When the number of instructor data items of the selected (N−1)-gram is less than the prescribed threshold value (step S502: No), the probability coefficient calculator 450 calculates the division probability coefficients of the selected (N−1)-gram using the division probability coefficients of the (N−2)-grams.

That is to say, the probability coefficient calculator 450 determines whether or not N−1 is 1 (step S504), and when N−1 is not 1, in other words when the (N−1)-grams are not mono-grams (step S504: No), N is decremented by 1 (step S505) and the calculation process is repeated (step S506). In this case, the division probability coefficients of the N-gram are found from the division probability coefficients of the (N−2)-grams.

On the other hand, when N−1 is 1 (step S504: Yes), in other words with the (N−1)-grams are mono-grams, it is impossible to further decrease N, so the probability coefficient calculator 450 generates the division patterns of the (N−1)-grams and sets those division probability coefficients to the default value (here, 0.5) (step S507).

Next, the determination unit 420 determines whether or not the process of steps S502 through 5507 for both of the (N−1)-grams generated in step S501 has concluded, that is to say whether or not all of the division probability coefficients for both (N−1)-grams have been found (step S508). If there is a division probability coefficient that has not been found for one of the (N−1)-grams (step S508: No), the probability coefficient calculator 450 selects the (N−1)-gram that has not been found (step S509) and repeats the process from steps S502 through S508.

On the other hand, when it is determined that all division probability coefficients have been found for both (N−1)-grams (step S508: Yes), the probability coefficient calculator 450 generates the division patterns that should acquire the division probability coefficients out of all division patterns that can be generated from the N-gram (step S510).

The probability coefficient calculator 450 defines a counter variable “k” and selects the kth division pattern of the generated division patterns (step S511). The initial value of the counter variable k is 1, and the counter variable k is an integer greater than or equal to 1. In the example in FIG. 14A and FIG. 14B, “1 Smoked 0 trout 0 fillet 1” is selected. In the example in FIG. 14C, on the first loop of the calculation process, “1 Smoked 0 trout 0” is selected, and on the second loop, “1 Smoked 0 trout 0 fillet 1” is selected.

The probability coefficient calculator 450 extracts the division pattern on the route to the division pattern selected in step S511 from among the division patterns of the (N−1)-grams generated in step S503 or step S507 (step S512).

The probability coefficient calculator 450 calculates the division probability coefficients of the division pattern selected in step S511 based on the division probability coefficients of the extracted division pattern (step S513).

The probability coefficient calculator 450 determines whether or not the division probability coefficients of all division patterns selected in step S510 have been calculated (step S514). If there is a division pattern for which the division probability coefficients have not been calculated (step S514: No), the probability coefficient calculator 450 increments the counter variable k (step S515) and repeats the process from steps S511 through S514.

On the other hand, when the division probability coefficients of all division patterns have been calculated (step S514: Yes), the probability coefficient calculator 450 concludes the calculation process.

As explained above, with the information processing device 1 according to this preferred embodiment, even when there are not enough instructor data items for the N-gram, it is possible to calculate the division probability coefficients of the N-gram using the division probability coefficients of the (N−1)-grams, (N−2)-grams and/or the like, and it is possible to determine with good precision divisions from the standpoint of the meaning of the input character string. Furthermore, the general-purpose nature of the information processing device 1 is increased.

In addition, even when the division probability coefficients of part of the N-gram cannot be obtained, it is possible to calculate the division probability coefficients of the N-gram based on the division probability coefficients of the (N−1)-grams and/or the like that can be obtained, so there is little deterioration of determination precision compared to calculating using the division probability coefficients of the (N−1)-grams and/or the like uniformly.

The present invention is not limited to the above-described preferred embodiments, for various variations and applications are possible. In addition, the various constituent elements of the above-described preferred embodiments can be freely combined.

The information processing device 1 composed of the information processing unit 701, the data memory unit 702 and the program memory unit 703 and/or the like can be realized using a regular computer system without using special systems. For example, an arbitrary computer can be caused to function as the information processing device 1 by a computer program for executing the processes explained in the above-described preferred embodiments being stored and distributed on a computer-readable recording medium (flexible disk, CD-ROM, DVD-ROM and/or the like), and this computer program being installed on the computer. In addition, the information processing device 1 may be realized by the computer program being stored on a memory device possessed by a server system on a communication network such as the Internet, and being downloaded and executed by a regular computer.

When the processes accomplished by the information processing device 1 are allocated between an OS (operating system) and application program and are realized through cooperation between the OS and application program, the application program portion alone may be stored on a recording medium or memory device.

It is also possible to overlay the computer program on carrier waves and distribute such via a communication network. For example, the computer program may be posted on a bulletin board system (BBS) on a communication network, and the computer program may be distributed via the network. Furthermore, the information processing device 1 may be realized by an arbitrary computer executing this computer program.

A portion of the process executed by the information processing device 1 may be executed by another computer differing from the information processing device 1.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An information processing device comprising:
a word string acquirer for acquiring a word string including a plurality of words;
an extractor for extracting partial strings including words contained in the word string acquired by the word string acquirer;
a division pattern generator for generating a plurality of division patterns containing division flags indicating whether or not the word string acquired by the word string acquirer is divided at spaces between the words contained in the partial strings extracted by the extractor;
a division probability coefficient acquirer for acquiring, for each division pattern, division probability coefficients indicating a degree of a certainty that the partial strings are divided with a division method indicated by the division patterns generated by the division pattern generator, for each of the partial strings extracted by the extractor; and
a partitioner for partitioning the word string acquired by the acquirer, based on the division probability coefficients acquired by the division probability coefficient acquirer.

2. The information processing device according to claim 1, further comprising a selector for selecting one division pattern from among the plurality of division patterns generated by the division pattern generator, on the basis of the division probability coefficients acquired by the division probability coefficient acquirer and the division probability coefficients of the division patterns adjacent to the partial strings of the division pattern and having division flag values in spaces contained in the partial strings in common, for each of the partial strings extracted by the extractor;
wherein the partitioner partitions the word string acquired by the word string acquirer, based on the division pattern selected by the selector.

3. The information processing device according to claim 2, further comprising a calculator for calculating route probability coefficients indicating a degree of a certainty of combinations of a first division pattern and any of a plurality of second division patterns, based on the division probability coefficients corresponding to the first division pattern of the partial string, and the division probability coefficients of a plurality of the second division patterns adjacent to the first division pattern;
wherein the selector selects the second division pattern with the largest route probability coefficients calculated by the calculator, from among the plurality of second division patterns adjacent to the first division pattern.

4. The information processing device according to claim 3, wherein the calculator sets the route probability coefficients to a default value when the calculated route probability coefficients exceed a prescribed value.

5. The information processing device according to claim 1, further comprising:
a shooter for shooting images containing word strings;
wherein the extractor extracts the word strings from the images shot by the shooter.

6. The information processing device according to claim 1, further comprising:
a display data generator for generating display data indicating the meaning of the words, for each of the words contained in the word string partitioned by and obtained from the partitioner; and
a display for displaying the display data generated by the display data generator.

7. The information processing device according to claim 3, wherein:
the selector selects the route whose calculated route probability coefficients are largest, from among the plurality of routes going from the division pattern corresponding to the partial string containing the first word of the word string to the division pattern corresponding to the partial string containing the last work of the word string; and
the partitioner partitions the word string using a division method in which a combination of the division patterns on the selected route is indicated.

8. The information processing device according to claim 1, further comprising:
a memory for storing in advance instructor data indicating the division method of the partial string;
wherein the division probability coefficient acquirer acquires the division probability coefficients based on the instructor data stored in the memory.

9. The information processing device according to claim 8, wherein:
the division probability coefficient acquirer calculates the division probability coefficients based on the instructor data when the number of instructor data items stored in the memory corresponding to the partial string is greater than or equal to a prescribed threshold value; and
the extractor further extracts a second partial string including one or more words contained in the extracted partial string and the division probability coefficient acquirer calculates the division probability coefficients based on the instructor data indicating the division method of the second partial string, when the number of instructor data items stored in the memory corresponding to the partial string is less than the prescribed threshold value.

10. The information processing device according to claim 9, wherein the acquirer sets the division probability coefficients to a default value when the number of instructor data items store in the memory corresponding to the partial string is less than the prescribed threshold value and the number of words contained in the extracted partial string is one.

11. The information processing device according to claim 1, wherein the partial string extracted by the extractor is an N-gram of the word string.

12. An information processing method comprising steps of:
acquiring a word string including a plurality of multiple words;
extracting partial strings including words contained in the acquired word string;
generating a plurality of division patterns containing division flags indicating whether or not the acquired word string is divided at spaces between the words contained in the extracted partial strings;
acquiring, for each division pattern, division probability coefficients indicating a degree of a certainty that the partial strings are divided with a division method indicated by the generated division patterns, for each of the extracted partial strings; and
partitioning the acquired word string , based on the acquired division probability coefficients.

13. A non-transitory information recording medium on which a program is stored that causes a computer to function as:
a word string acquirer for acquiring a word string including a plurality of words;
an extractor for extracting partial strings including words contained in the word string acquired by the word string acquirer;
a division pattern generator for generating a plurality of division patterns containing division flags indicating whether or not the word string acquired by the word string acquirer is divided at spaces between the words contained in the partial strings extracted by the extractor;
a division probability coefficient acquirer for acquiring, for each division pattern, division probability coefficients indicating a degree of a certainty that the partial strings are divided with a division method indicated by the division patterns generated by the division pattern generator, for each of the partial strings extracted by the extractor; and
a partitioner for partitioning the word string acquired by the word string acquirer, based on the division probability coefficients acquired by the division probability coefficient acquirer.
